(19) United States
(12) Patent Application Publication
(10) Pub. No.: US 2026/0239213 A1
(43) Pub. Date: Aug. 13, 2026

(54) Non-Access Stratum and Core Network Enhancements for Low Power Wake Up Signal (WUS) Paging Subgrouping

(71) Applicant: Apple Inc., Cupertino, CA (US)

(72) Inventors: Vivek G. Gupta, San Jose, CA (US); Sridhar Prakasam, Fremont, CA (US)

(21) Appl. No.: 19/461,159

(22) Filed: Jan. 27, 2026

Related U.S. Application Data
(60) Provisional application No. 63/756,025, filed on Feb. 7, 2025.

(51) Int. Cl. H04W 52/02; H04W 8/22; H04W 60/04; H04W 68/02

(52) U.S. Cl. CPC H04W 52/0235; H04W 8/22; H04W 60/04; H04W 68/02

(57) ABSTRACT

Systems and methods for wireless communication are configured for sending a registration request message indicating low power wake-up signal (LP-WUS) assistance information, the registration request configured to register a device for services from a network; receiving a registration accept message that indicates a paging subgroup identifier that assigns the device to a paging subgroup based on the LP-WUS assistance information and a new globally unique temporary identifier (GUTI) corresponding to the assigned paging subgroup; and sending a registration complete message indicating that the device is responsive to paging requests including the paging subgroup identifier.

### CROSS-REFERENCE TO RELATED APPLICATIONS

This application claims priority to U.S. Provisional Patent Application No. 63/756,025, filed on Feb. 7, 2025, the entire content of which is incorporated herein by reference.

### TECHNICAL FIELD

This disclosure relates generally to wireless communications.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

The non-access stratum (NAS) includes a functional layer in the NR, LTE, Universal Mobile Telecommunications System (UMTS), and Global System for Mobile Communications (GSM) wireless telecom protocol stacks between the Core Network (CN) and User Equipment (UE). NAS manages the establishment of communication sessions and maintains continuous communications with a user equipment (UE) as it moves. Once the UE establishes a radio connection, the UE uses the radio connection to communicate with core nodes to coordinate service. The UE can perform a registration process with the NAS to verify the UE identity. Verification ensures a secure and reliable communication with the UE before accessing the network.

### BRIEF DESCRIPTION OF THE FIGURES

FIG. 1 illustrates a wireless network.

FIG. 2 illustrates a process for UE subgroup identifier (ID) assignment.

FIG. 3 illustrates a process for UE subgroup identifier assignment including UE registration failure.

FIG. 4 illustrates a process for UE capability exchange with the network and UE subgroup ID assignment.

FIG. 5 illustrates a process for UE capability exchange with the network and UE subgroup ID assignment.

FIG. 6 illustrates an example UE, according to some implementations.

FIG. 7 illustrates an access node, according to some implementations.

### DETAILED DESCRIPTION

This disclosure describes systems and processes for assigning a UE to a paging subgroup based on UE LP-WUS capabilities information. The UE will receive paging requests with other UEs of the paging subgroup. The subgrouping definitions can be applied by the CN or based on UE identifiers (UEID). UE assistance information can be provided by the UE to the Access and Mobility Management Function (AMF) for registration of the UE with the CN, and the AMF uses the UE assistance information to assign the UE to a paging subgroup, such as with other UEs having similar capabilities. The UE and network can determine each other's paging subgrouping capabilities and determine whether to use CN-based subgrouping or UEID-based subgrouping. This disclosure describes the NAS signaling that assigns a CN-based paging subgroup identifier to a UE and how the AMF indicates a CN-based paging subgroup identifier to a node (e.g., a next generation node (gNB)).

A UE can operate in an idle/inactive mode to conserve power when some UE functions are not needed. When the UE is needed by the network, the network can send a wake-up signal (WUS) to the UE. The UE periodically monitors for the WUS. For example, the UE will wake-up at a subframe where the UE expects a paging occasion (PO) and reads the paging messages. The paging messages include a temporary mobile subscriber identity (TMSI) value for the UE. If the UE does not find the TMSI of the UE inside the paging messages, the UE assumes that it is not paged, and it will go back to idle mode. However, if the UE finds the TMSI for the UE in one of the paging messages, the UE determines that the page is addressed to it, and it will initiate a radio resource control (RRC) connection. When the UE is not the intended target of the paging message, the UE has unnecessarily woken up and wasted power, as described in further detail below.

A UE can include a low power wake up radio (LR) and a main radio (MR). In an idle state (also called an inactive state or deep sleep state), the MR of the UE can be turned off to conserve power while the LR, which consumes less power, remains on. The UE can use the LR to detect the LP-WUS and turn on the MR to resume operations. The LR has the ability to monitor wake-up signal with ultra-low power consumption. The power consumption for monitoring wake-up signal depends on the wake-up signal design and the hardware module of the wake-up receiver used for signal detecting and processing. The MR consumes more power than the LR but has greater functionality than the LR (such as for transmission and reception of signals) and is configured for paging reception in the idle/inactive state. For example, the LR may be able to receive signals using a relatively limited range of frequencies in comparison to the MR of the UE.

The network sends paging messages to UEs which operate in the active state to receive and respond to them. A UE can be configured with a specific identifier (UEID) based on whether the UE is in an idle/inactive state. The UE determines, based on the UEID, a Paging Frame (PF) and a Paging Occasion (PO) for which the UE is expected to receive a page from the network.

Multiple UEs can monitor a same paging occasion in expectation of a network-initiated page because the number of paging frames and paging occasions are limited. When there is a paging message for one of many UEs monitoring a same PO, each of the many UEs receives the associated paging message on the Physical Downlink Shared Channel (PDSCH). However only a particular UE acts on the paging request. This UE is the UE for which a UE identifier in any of the paging records matches that UE's UEID. The other UEs ignore the paging message and can return to an idle mode. When a UE wakes up and receives a paging message (e.g., on the PDSCH) that is not intended for that UE, that UE has received a false page, and power has been wasted by that UE. When a large number of UEs monitor a same PO, many UEs unnecessarily receive and decode PDSCH, which increasing UE power consumption overall, because Physical Downlink Control Channel (PDCCH) and PDSCH processing power consumption in L1 several times higher than power consumption of processing only PDCCH. In some implementations, the network sends a paging message to up to 32 UEs in a single PO. A paging record list enables the network to handle burst of paging requests when there is an instantaneous high load of paging requests.

When the network initiates a page to the UE, in the absence of cell level information of where the UE is located, the network may start with a given tracking area/radio access network (RAN) notification area, with an intent to reach the UE. The network may progressively increase the scope of paging by repeating it across a bigger geography when the network does not receive any response from the intended UE for its previous paging attempt. The network can try to increase the paging area scope to include additional areas if the previous paging attempt was unsuccessful, resulting in extraneous false pages for the other non-intended idle/inactive UEs.

To reduce a false page probability, the network can divide UEs into paging subgroups. The network can map a smaller number of UEs per paging occasion to reduce the number of associated UEs that are unintentionally woken up while trying to deliver a page to the intended UE. The subgroups of UEs can be defined using LP-WUS (e.g., CN-assigned and UEID-based subgroups). In some implementations, a maximum number of subgroups that can be configured for LP-WUS subgrouping is no less than 8 (e.g., 32). When the UE is configured with CN-based LP-WUS subgrouping, the CN assigns the LP-WUS subgroup ID to the UE. The network performs paging sub-grouping by dividing UEs within a PO into multiple subgroups. A UE will decode the Paging message in its Paging occasion only if the UE receives an indication that its subgroup is being paged.

For WUS (or paging early indication (PEI) based paging subgrouping of UEs, the network transmits an early indication or wake-up signal before paging occasion. The indication or WUS may applies to a subgroup of UEs, as described previously. The UE does not monitor the PO in case of a negative indication. For CN-assigned subgrouping, the AMF assigns a paging subgroup ID to the UE based on UE Assistance information including a paging probability value and UE power profile for the UE. The AMF indicates a paging subgroup ID to the UE using NAS signaling. The AMF also sends subgroup information to the node (e.g., gNB) for paging the UE which is in an idle/inactive state. Nodes may inform each other about a UE's paging subgroup ID for RAN paging.

For UEID-based subgrouping, a node determines a total number of subgroups for a UEID based subgrouping in a cell. The node broadcasts the total number of subgroups for the UEID based subgrouping in a cell. When a paging message for the UE is received from the CN to the node or is generated by the node, the node determines the PO (and associated PEI) for the UE. Before the UE is paged in the PO, the node transmits the paging request (e.g., transmits the associated PEI) indicates the subgroup(s) of the UE(s) that are paged (e.g., in the PEI) if supported by the UE(s).

This disclosure describes information elements (IEs) that support LP-WUS based UE subgrouping. A base station broadcasts to a UE that the base station supports low power wake up signal based power management and assigns a paging subgroup. The UE sends a registration request message to the network that includes UE capability to support low power wake up signals, and it includes the assistance information. For example, the assistance information can include a paging probability value (e.g., 0-100 in increments of 5 or as a range). The UEs are grouped to have similar paging probability values so that the UEs in a group are approximately equally likely to be the target of a paging message targeted at the group. The UE assistance information includes power profile information for the UE. For example, the power profile may indicate a device type, such as a mobile phone, IoT sensor, machine type communication (MTC) device, and so forth. The power profile may indicate an expected battery duration for the device (e.g., days, months, or years). The power profile may indicate an available power budget for the UE, such as a low, medium, or high budget. The UEs can be grouped based on these parameter values.

The network then evaluates the assistance information based on the UE characteristics, the heuristics, and other information. The network sends a registration accept message to the UE that includes the paging subgroup ID and a new globally unique temporary identifier (GUTI). The UE sends a registration complete message and starts using the new paging subgroup ID. After getting the registration complete message, the network sends the gNodeB (RAN) a context modification request message to update the UE the paging subgroup ID and the RAN sends a UE context modification response that acknowledges the change to the core network. If the network decides to do some UE regrouping, the network can send a configuration update command message to the UE include the paging subgrouping and the UE sends a configuration update complete message back to the network. The network then starts paging, and the UE monitors the paging based on the new the new subgroup ID. Details of the signaling supporting this process is described herein.

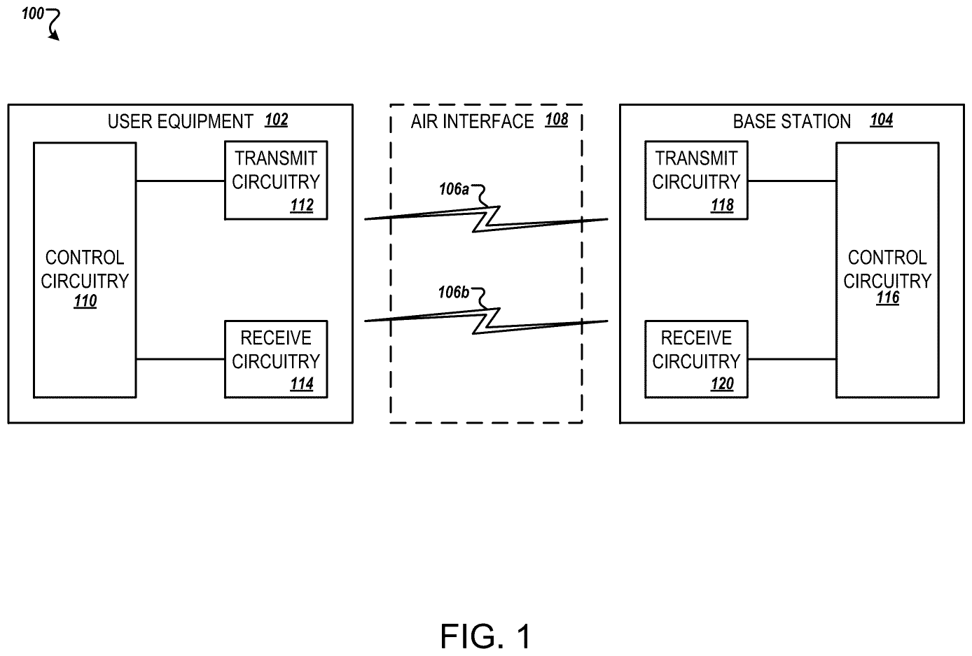

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be a E-UTRA (Evolved Universal Terrestrial Radio Access)-NR Dual Connectivity (EN-DC) network, or a NR-EUTRA Dual Connectivity (NE-DC) network. However, the wireless network 100 may also be a Standalone (SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE.

The transmit circuitry 112 can perform various operations described in this specification. Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

UEs can be included in systems for both mobile telephony and vertical use cases. A UE can consume tens of milliwatts while in a radio resource control (RRC) idle/inactive state and hundreds of milliwatts in RRC connected state. LP-WUS operation can be useful for UEs operating in low-power contexts, such as Internet of Things (IoT) networks. IoT devices can include lightweight UEs that are configured to connect to a base station. Lightweight UEs can include UEs with low power availability and computing bandwidth. The lightweight UEs may require connections with relatively low latencies (e.g., ultra-low latency connections (ULLCs)), relatively low power usages, relatively high reliabilities or low packet losses, high peak data bandwidths, and so forth. For example, UEs without a continuous energy source can include UEs using small rechargeable and single coin cell batteries such as (for vertical use cases) sensors and actuators that are deployed extensively for monitoring, measuring, charging, etc. These devices may have batteries that are not rechargeable and expected to last at least few years. In some implementations, low power UEs can include wearables such as smart watches, rings, eHealth related devices, and medical monitoring devices that may be required, with typical battery capacity, to operate up to 1-2 weeks without access to supplemental power. The LP-WUS can allow a UE to achieve power savings without adding latency.

UE power consumption depends on a configured length of wake-up periods, which depend on a paging cycle of the network. To meet battery life requirements in low power contexts, the network may extend the period of paging cycles with an extended Discontinuous Reception (eDRX) cycle. The eDRX cycle can result in a relatively higher latency (relative to DRX) to reduce power consumption. For applications with strict latency requirements (e.g., a safety sensor), the latency of eDRX may be too long. Using the LP-WUS, MR, and LR, the UE does not need to periodically wake up once per DRX cycle, which dominates the power consumption in periods with no signaling or data traffic. Instead, the UE can wake up only when triggered, and power consumption can be reduced. The LP-WUS or wake up receiver (WUR) can be used to trigger UE MR paging monitoring, allowing the UE to stay in deep sleep longer and consume less power, such as up to 90% less power, compared to use of DRX. LP-WUS can enable a paging latency reduction and UE power saving gain when the paging monitoring is performed by the MR wake-up is performed.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels includes of a plurality of downlink subframes. The receive circuitry 120 may receive a plurality of uplink physical channels from various UEs, including the UE 102.

In FIG. 1, the one or more channels 106A, 106B are illustrated as an air interface to enable communicative coupling, and can be consistent with cellular communications protocols, such as a GSM protocol, a CDMA network protocol, a UMT S protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

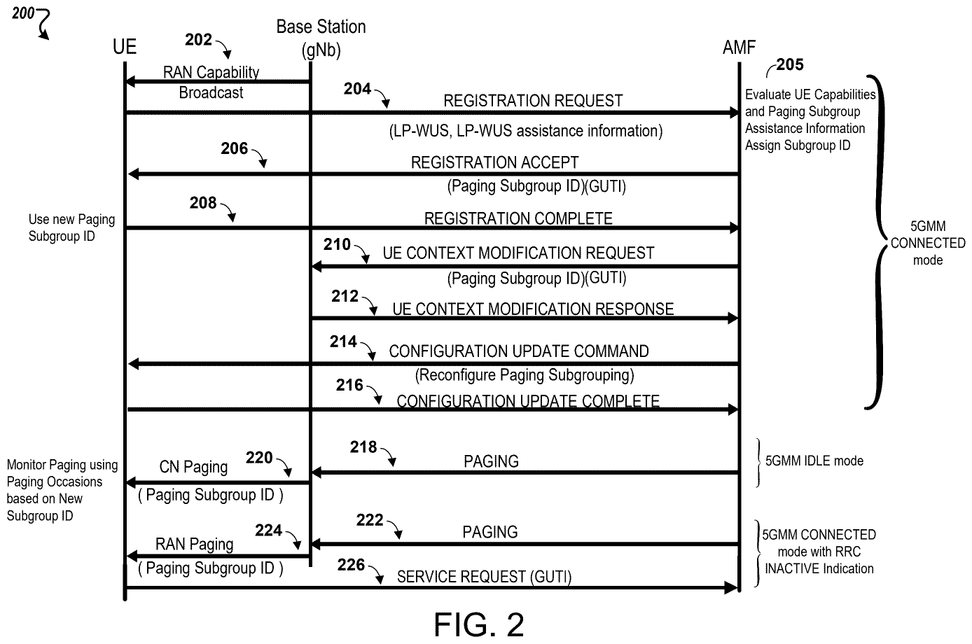

FIG. 2 illustrates a process 200 for UE capability exchange with the network and UE subgroup identifier (ID) assignment. A network node (e.g., a gNB or base station) broadcasts (202) RAN capability information to the UE. The RAN capability information indicates support for CN subgrouping and UEID based subgrouping by the network. The RAN capability information indicates a total number N_{sg} of subgroups supported (e.g., 32 subgroups).

The UE sends (204) a registration request to the AMF after the RAN capability information is received. In the registration request to the AMF, the UE provides the LP-WUS information and LP-WUS assistance information that indicates UE capabilities to the AMF for assigning the UE to a paging subgroup. The content of the registration request information (including the assistance information) is subsequently described.

The UE sends a mobility management (MM) capability information element (IE) to the AMF. The MM IE indicates to the AMF the capabilities of the UE, such as whether the UE can support LP-WUS operation among other capabilities indicators (e.g., indicators of IoT capability, voice centric capability, and so forth). LP-WUS capabilities information can be indicated in an example MM IE in octet 12-15, as shown in the example IEs expressed as Table 1 below. In an example, a “1” in the LP-WUS field indicates capability of the UE for LP-WUS, and a “0” in the LP-WUS field indicates no capability of the UE for LP-WUS.

TABLE 1
5G MM IEs

| 8 | 7 | 6 | 5 | 4 | 3 | 2 | 1 | |
|---|---|---|---|---|---|---|---|---|
| 5GMM capability IEI | | | | | | | | octet |
| | | | | | | | | 1 |
| Length of 5GMM capability contents | | | | | | | | octet |
| | | | | | | | | 2 |
| SGC | 5G- | N3 data | 5G-CP | RestrictEC | LPP | HO | S1 | octet |
| | IPHC- | | CIoT | | | attach | mode | 3 |
| | CP CIoT | | | | | | | |
| RACS | NSSAA | 5G-LCS | V2XCNP | V2XCEP | V2X | 5G-UP | 5GSRVCC | octet |
| | | | C5 | C5 | | CIoT | | 4* |
| 5G | 5G | 5G | ER- | 5G-EHC- | multipleUP | WUSA | CAG | octet |
| ProSe- | ProSe- | ProSe-dd | NSSAI | CP CIoT | | | | 5* |
| 12relay | dc | | | | | | | |
| PR | RPR | PIV | NCR | NR-PSSI | 5G ProSe- | 5G | 5G | octet |
| | | | | | 13rmt | ProSe- | ProSe- | 6* |
| | | | | | | 12rmt | 13relay | |
| MPSIU | UAS | NSAG | Ex-CAG | SSNPNSI | Event | MINT | NSSRG | octet |
| | | | | | Notification | | | 7* |
| SBTS | NSR | LADN- | RAN | ECI | ESI | RCMAN | RCMAP | octet |
| | | DS | timing | | | | | 8* |
| 5G | 5G | 5G | RSLPS | SBNS | UN-PER | A2XNPC5 | A2XEPC5 | octet |
| ProSe- | ProSe- | ProSe- | | | | | | 9* |
| 12end | 13U2U | 12U2U | | | | | | |
| | relay | relay | | | | | | |
| A2X- | SLVI | TempNS | SUPL | LCS-UPP | PNS | RSLP | 5G | octet |
| Uu | | | | | | | ProSe- | 10* |
| | | | | | | | 13end | |
| LP- | RATUC | RSLPPU | RSLPVU | NSUC | RSLPL | NVL- | MCSIU | octet |
| WUS | | | | | | SATNR | | 11* |
| 0 | 0 | 0 | 0 | 0 | 0 | 0 | 0 | octet |
| | | | | | | | | 12*-15* |

Spare

The MM capability IE provides the network with information concerning aspects of the UE related to the CN or interworking with the EPS. In this example, the AMF can determine that the UE is capable of LP-WUS. The UE capability information can be included in a type 4 IE with a minimum length of 3 octets and a maximum length of 15 octets, shown in Table 1. The UE indication of support for LP-WUS (LP-WUSSI) is shown in octet 11 at bit 8. This bit indicates the capability to support LP-WUS, as described previously.

The LP-WUS assistance information ty includes assistance information that indicates to what kind of paging subgroup the UE should be assigned by the network used for LP-WUS when paging the UE. The assistance information can indicate the current subgroup ID of the UE. The coding of the information element allows the UE to combine different types of LP-WUS assistance information. In some implementations, the LP-WUS assistance information is a type 4 information element, with a minimum length of 3 octets. Table 2 shows an example configuration of a LP-WUS assistance information IE.

TABLE 2
LP-WUS assistance information IE

| | | | | | | | |
|---|---|---|---|---|---|---|---|
| 8 | 7 | 6 | 5 | 4 | 3 | 2 | 1 |

| LP-WUS assistance information IE | octet 1 |
|---|---|
| Length of LP-WUS assistance information contents | octet 2 |
| LP-WUS assistance information type 1 | octet 3 |
| | . . . |
| | octet i |
| LP-WUS assistance information type 2 | octet i + 1* |
| | . . . |
| | octet 1* |
| . . . | octet 1 + 1* |
| | . . . |
| | octet m* |
| LP-WUS assistance information type p | octet m + 1* |
| | . . . |
| | octet n* |

In some implementations, the LP-WUS IE associates a type of UE information with a LP-WUS subgroup ID value. Table 3 shows an example of LP-WUS assistance information type (type of information=“000”).

TABLE 3
LP-WUS assistance information type 0

| | | | | | | | |
|---|---|---|---|---|---|---|---|
| 8 | 7 | 6 | 5 | 4 | 3 | 2 | 1 |

| | | |
|---|---|---|
| Type of information | LP-WUS subgroup ID value | octet 1 |

The assistance information can include a paging probability value that is indicated by the UE. UEs are grouped to have similar paging probability values so that the UEs in a group are approximately equally likely to be the target of a paging message targeted at the group. Table 4 shows an example of UE LP-WUS assistance information in which the UE paging priority value is reported to the AMF (type of information=“000”).

TABLE 4
LP-WUS assistance information type 1

| | | | | | | | |
|---|---|---|---|---|---|---|---|
| 8 | 7 | 6 | 5 | 4 | 3 | 2 | 1 |

| | | |
|---|---|---|
| Type of information | UE paging probability information value | octet 1 |

The UE assistance information includes power profile information for the UE. For example, the power profile may indicate a device type, such as a mobile phone, IoT sensor, MTC device, and so forth. The power profile may indicate an expected battery duration for the device (e.g., days, months, or years). The power profile may indicate an available power budget for the UE, such as a low, medium, or high budget. The UEs can be grouped based on these parameter values.

In an example, the LP-WUS assistance information IE includes the LP-WUS type indication in the most significant 3 bits (bits 8, 7, and 6) and probability values are signaled in the least significant bits (bits 5 to 1). Table 5 shows an example assistance information IE including values for the information type. Table 6 shows the example assistance information IE including the probability values. The paging subgroup ID can be bits one to five and that will cover up to 32 groups. The bits can define the paging probability.

TABLE 5
LP-WUS IE Information Type (MSB)
Type of information (octet 1)
Bits

| 8 | 7 | 6 | |
|---|---|---|---|
| 0 | 0 | 0 | LP-WUS subgroup ID |
| 0 | 0 | 1 | UE paging probability information |

TABLE 6
LP-WUS IE Probability Values (LSB)
Bit

| 5 | 4 | 3 | 2 | 1 | UE paging probability information value |
|---|---|---|---|---|---|
| 0 | 0 | 0 | 0 | 0 | p00 (UE calculated paging probability is 0%) |
| 0 | 0 | 0 | 0 | 1 | p05 (UE calculated paging probability >0% and <=5%) |
| 0 | 0 | 0 | 1 | 0 | p10 (UE calculated paging probability >5% and <=10%) |
| 0 | 0 | 0 | 1 | 1 | p15 (UE calculated paging probability >10% and <=15%) |
| 0 | 0 | 1 | 0 | 0 | p20 (UE calculated paging probability >15% and <=20%) |
| 0 | 0 | 1 | 0 | 1 | p25 (UE calculated paging probability >20% and <=25%) |
| 0 | 0 | 1 | 1 | 0 | p30 (UE calculated paging probability >25% and <=30%) |
| 0 | 0 | 1 | 1 | 1 | p35 (UE calculated paging probability >30% and <=35%) |
| 0 | 1 | 0 | 0 | 0 | p40 (UE calculated paging probability >35% and <=40%) |
| 0 | 1 | 0 | 0 | 1 | p45 (UE calculated paging probability >40% and <=45%) |
| 0 | 1 | 0 | 1 | 0 | p50 (UE calculated paging probability >45% and <=50%) |
| 0 | 1 | 0 | 1 | 1 | p55 (UE calculated paging probability >50% and <=55%) |
| 0 | 1 | 1 | 0 | 0 | p60 (UE calculated paging probability >55% and <=60%) |
| 0 | 1 | 1 | 0 | 1 | p65 (UE calculated paging probability >60% and <=65%) |
| 0 | 1 | 1 | 1 | 0 | p70 (UE calculated paging probability >65% and <=70%) |
| 0 | 1 | 1 | 1 | 1 | p75 (UE calculated paging probability >70% and <=75%) |
| 1 | 0 | 0 | 0 | 0 | p80 (UE calculated paging probability >75% and <=80%) |
| 1 | 0 | 0 | 0 | 1 | p85 (UE calculated paging probability >80% and <=85%) |
| 1 | 0 | 0 | 1 | 0 | p90 (UE calculated paging probability >85% and <=90%) |
| 1 | 0 | 0 | 1 | 1 | p95 (UE calculated paging probability >90% and <=95%) |
| 1 | 0 | 1 | 0 | 0 | p100 (UE calculated paging probability >95% and <=100%) |

The UEs of a paging subgroup receive paging requests with other UEs of the paging subgroup. The subgrouping definitions can be applied by the CN. In this example, the AMF assigns the subgroup ID to the UE based on the assistance information provided to the AMF by the UE. UEs having similar capabilities are assigned to a same subgroup because they are more likely to be paged under similar circumstances.

As discussed, the registration request message is sent from the UE to the network (e.g., the AMF). The requested LP-WUS assistance information may include the IE shown in Table 7 if the UE supports LP-WUS, the UE is not performing initial registration for emergency services, is not registered for emergency services, and does not have an active emergency PDU session. Table 7 shows an example of the registration request message content.

TABLE 7
IE for Registration Request

| | Information | | | | |
|---|---|---|---|---|---|
| IE | Element | Type/Reference | Presence | Format | Length |
| IE# | Requested | LP-WUS | O | TLV | 3-n |
| | LP-WUS | assistance | | | |
| | assistance | information | | | |
| | information | | | | |

As discussed, the UE indicates its capability (e.g., for LP-WUS) and includes LP-WUS assistance information in the registration request message during either initial registration (not for emergency services) or a mobility and periodic registration update (MRU). For example, the capability and assistance information can be provided for 4G to 5G transitions, entering new timing advances (TAs), changes in UE Assistance information (PSAI), based on network configuration, and so forth. For example, the UE generally registers within a particular duration of time (e.g., within 54 minutes). If the UE does not register, the network may deregister the UE. The UE can initiate registration when transitioning to a new cell or during mobility operations (e.g., as part of mobility management) to ensure that the registration threshold is met (e.g., if the UE subsequently loses connectivity).

The AMF evaluates (205) the UE capabilities information and assigns a subgroup to the UE. For example, the AMF evaluates the UE support for paging subgrouping and UE paging subgrouping assistance information and assigns a CN subgroup ID. The AMF sends (206) a registration accept message to the UE.

In an aspect the registration accept message is sent by the AMF to the UE in an IE called the negotiated LP-WUS assistance information IE. The network includes the negotiated LP-WUS assistance information IE if the UE supports LP-WUS, the AMF supports and accepts the use of LP-WUS assistance information for the UE, and the UE is not performing initial registration for emergency services and does not have an active emergency PDU session. Table 8 shows an example negotiated LP-WUS assistance information IE. The AMF also includes a new GUTI in the registration accept message.

TABLE 8
Negotiated LP-WUS assistance information IE

| | Information | | | | |
|---|---|---|---|---|---|
| IE | Element | Type/Reference | Presence | Format | Length |
| IE# | Negotiated | LP-WUS | O | TLV | 3-n |
| | LP-WUS | assistance | | | |
| | assistance | information | | | |
| | information | | | | |

The UE responds (208) to the AMF with a registration complete message to confirm reception of the paging subgroup ID and end the assignment procedure. The UE starts monitoring paging based on new Paging Subgroup ID.

The AMF can indicate the UE's subgroup ID to a base station (e.g., the gNB). After sending the registration accept message to the UE, the AMF sends (210) a UE context modification request message to the base station indicating the UE's paging subgroup ID. The base station can respond (212) with a UE context modification response message that indicates whether the base station was successful in updating the UE context information based on the previous UE context modification request message. Specifically, the AMF, after sending the registration accept message to the UE, sends the UE context modification request to the RAN that includes the paging subgroup ID. The RAN can then page the UE on this particular subgroup ID. The RAN capability reporting indicates support for co-network subgrouping and new ID based subgrouping and includes a total number of subgroups.

In an aspect, the AMF sends (214) a configuration update command message to the UE to reconfigure idle/inactive paging subgrouping. The UE responds (216) with configuration update complete message if the configuration was successfully updated. The AMF may send the configuration update message IE to the UE if the UE supports LP-WUS, the AMF supports and accepts the use of LP-WUS assistance information for the UE, the UE is not registered for emergency services, the UE does not have an active emergency PDU session, and the network needs to update LP-WUS assistance information for the UE. Table 9 shows an example of the updated LP-WUS assistance information IE of the configuration update message.

TABLE 9
Updated LP-WUS assistance information IE

| | Information | | | | |
|---|---|---|---|---|---|
| IE | Element | Type/Reference | Presence | Format | Length |
| IE# | Updated LP-WUS | LP-WUS | O | TLV | 3-n |
| | assistance | assistance | | | |
| | information | information | | | |

When the UE is in a low power, idle mode, the UE can be paged by the network depending on the subgroup ID associated with the UE. The AMF sends (218) a paging message to the base station. The base station, based on the subgroup ID associated with the UE, sends (220) a CN paging request to the UE (and other UEs associated with the subgroup ID). The UE is configured to monitor paging using paging occasions based on its paging subgroup ID. For a MM connected mode with RRC inactive indication, the AMF sends (222) a paging request to the base station. The base station can send (224) a RAN paging request based on the paging subgroup ID. The UE is configured to monitor paging using paging occasions based on its paging subgroup ID. A service request message is sent (226) with the GUTI of the UE.

In an aspect, for low-power wake-up signal and paging subgrouping, a UE may indicate its capability to support low-power wake-up signal paging subgrouping (LP-WUS) during registration procedure when the UE: initiates a registration procedure with 5GS registration type IE not set to “emergency registration”; and does not have an active emergency PDU session. If a UE supporting LP-WUS did not indicate its capability to support LP-WUS during the last registration procedure due to an active emergency PDU session over 3GPP access, the UE shall initiate a registration procedure for mobility and periodic registration update to indicate its capability to support LP-WUS after the emergency PDU session is released over 3GPP access. If the UE indicates support of LP-WUS the UE may include its paging probability information in the Requested LP-WUS assistance information IE in the registration request message. If the UE indicates support of LP-WUS and the network supports and accepts the use of the LP-WUS assistance information for the UE, the network provides to the UE the Negotiated LP-WUS assistance information, including the LP-WUS subgroup ID, in the registration accept message or the configuration update command message. The LP-WUS subgroup ID is used to determine the paging subgroup for LP-WUS when paging the UE. The UE NAS layer shall indicate the LP-WUS subgroup ID to the access stratum layer. The network shall store the LP-WUS subgroup ID in the 5GMM context of the UE.

The UE shall use LP-WUS assistance information only if the UE received the Negotiated LP-WUS assistance information IE during the last registration procedure. If the UE did not receive the Negotiated LP-WUS assistance information IE during the last registration procedure, the UE shall delete any existing LP-WUS assistance information received from the network. If the network did not accept the request to use LP-WUS assistance information during the registration procedure, the network shall delete the stored LP-WUS assistance information for the UE, if available. If the UE supports the use of the LP-WUS assistance information and the network supports and accepts the use of the LP-WUS assistance information, the network may provide the LP-WUS assistance information to the UE by including the Updated LP-WUS assistance information IE in the configuration update command message.

When an emergency PDU session is successfully established over 3GPP access after the UE received the Negotiated LP-WUS assistance information IE during the last registration procedure, the UE and the AMF shall not use LP-WUS assistance information until: the successful completion of the PDU session release procedure of the emergency PDU; the UE receives LP-WUS assistance information during a registration procedure with PDU session status IE or upon successful completion of a service request procedure, if the UE or the network locally releases the emergency PDU session; the successful completion of handover of emergency PDU session to non-3GPP access; or the successful transfer of the emergency PDU session in 5GS to the EPS or ePDG connected to EPC.

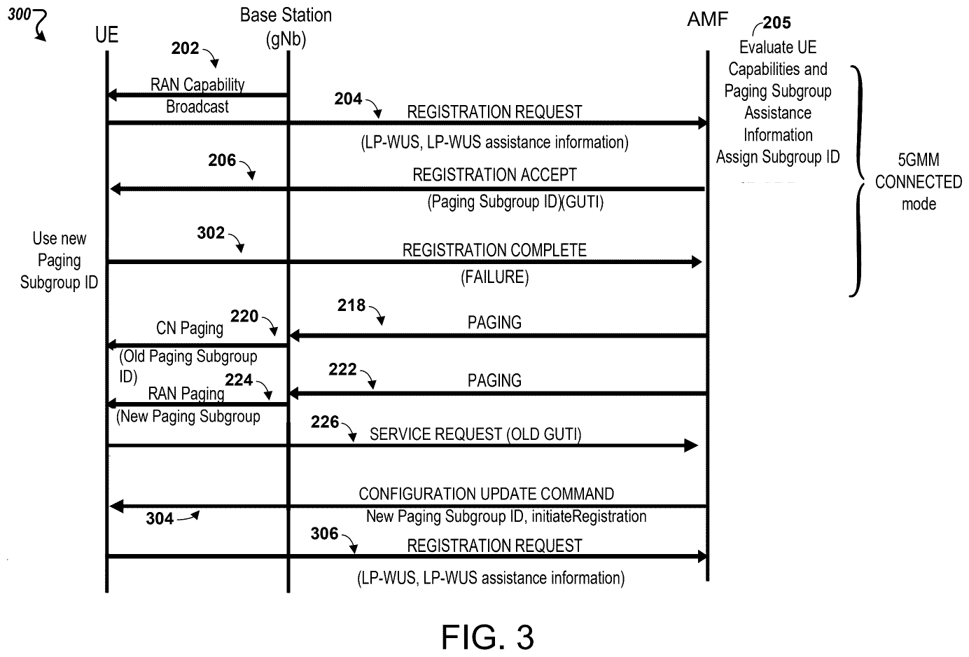

FIG. 3 illustrates a process 300 for UE capability exchange with the network and UE subgroup identifier assignment including UE registration failure. Process 300 is similar to process 200, except in this example, the registration completion is failed by the UE. Process 300 is used for abnormal case handling with lower layer failure for the registration complete message. Failure can occur when the UE does not connect to the network for an extended period of time or otherwise deregisters or does not receive the registration accepted message properly, such as because of a lower layer link failure.

When registration fails, the network (e.g., AMF) does not get a confirmation that the UE has received the subgroup ID which was sent by the network. The network has not determined whether the UE is using old subgroup ID or whether the UE is using the new subgroup ID. The UE has not yet determined whether the network will page the UE on the old subgroup ID or whether the network will page on a new subgroup ID. For example, if the UE received the new subgroup ID but was not able to send the complete message, the UE should determine which subgroup ID to expect in paging requests from the network. The AMF may realize failure has occurred when the registration accept message does not include the paging subgroup ID or is not received.

To resolve this potential issue, the AMF can send (304) a configuration update command to the UE if the AMF does not receive a configuration update complete message identifying the correct subgroup ID. The AMF can indicate a current configuration of paging subgroup ID as invalid. The AMF can include a new paging subgroup ID in this message. Alternatively, the AMF can request that the UE initiate the registration procedure again (e.g., as soon as possible) to retrieve the new paging subgroup ID. The UE can respond by initiating the new registration procedure or confirming the new subgroup ID.

In an aspect, the network may need to page the UE during a duration in which the network does not know deterministically which particular paging subgrouping ID is assigned to the UE. In this case, the network pages the UE on both the old paging subgroup ID and the new paging subgroup ID. The network can page on both IDs until a service request message is received or until the network requests that the UE send (306) a new registration to the network.

If the UE is still using the old subgroup ID and receives a paging request with the old subgroup ID and the new subgroup ID, the UE responds with a service request message and a globally unique temporary identifier (GUTI). When the network changes the paging subgrouping ID for a UE, the network requests that the UE to use a new GUTI. The network assigns a new GUTI to the UE after a registration procedure (after receipt of a registration request message). The UE uses the new GUTI. When the registration accept message is successful, the UE receives a new paging subgroup ID and also a new GUTI value. When the UE is paged both with the old paging subgroup ID and with the new paging subgroup ID, the UE responds with the corresponding GUTI, which may correspond to the new subgroup if the new paging subgroup was assigned successfully. If registration was unsuccessful, the UE responds to the paging message by including the old GUTI in the service request message that was previously assigned in a prior successful registration.

When the network receives the service request message from the UE for the paging based on the old or new GUTI that the UE has used, the network determines whether the UE is using the old paging subgroup ID or the new paging subgroup ID. If the UE is using the old paging subgroup identifier, the network sends (304) the configuration update command message, assigning the new paging subgroup ID if it was not delivered successfully. If the registration accept message was delivered successfully, the network can still send the configuration update command message not including the new paging subgroup ID but requesting that the UE perform the registration again to ensure that the UE has the proper subgroup ID. Based on the mapping between the GUTI and the paging subgroup ID, the network can determine which particular paging subgroup ID the UE is using.

In an aspect, if a lower layer failure occurs before the message registration complete has been received from the UE and timer T3550 is running, the AMF shall abort the procedure, enter 5GMM-IDLE mode. If a new 5G-GUTI was assigned to the UE in the registration accept message, the AMF shall consider both, the old and new 5G-GUTIs as valid until the old 5G-GUTI can be considered as invalid by the AMF. If a new TAI list was provided in the registration accept message, both the old and new TAI lists shall also be considered valid until the old TAI list can be considered invalid by the AMF. If the old 5G-GUTI was allocated by an AMF other than the current AMF, the current AMF does not need to retain the old 5G-GUTI

Additionally, if the registration accept message includes: 1) Negotiated WUS assistance information IE containing a new Paging subgroup ID and the UE is previously assigned a different Paging subgroup ID then, the AMF shall consider both, the old and new Paging subgroup IDs as valid until the old Paging subgroup ID can be considered as invalid by the AMF; or 2) Negotiated WUS assistance information IE containing no Paging subgroup ID or no Negotiated WUS assistance information IE, then the AMF shall delete any old Paging subgroup ID stored in the 5GMM context of the UE.

During this period, if the new 5G-GUTI is used by the UE in a subsequent message, then: i) the AMF shall consider the old 5G-GUTI as invalid and, additionally, the old TAI list as invalid if a new TAI list was provided with the new 5G-GUTI in the registration accept message; and ii) if the AMF assigns a new Paging subgroup ID to the UE in the registration accept message, then, the AMF shall consider the new Paging subgroup ID as valid and the old Paging subgroup ID, if any, as invalid.

During this period, if the old 5G-GUTI is used by the UE in a subsequent message, the AMF may use the identification procedure followed by a generic UE configuration update procedure. If the AMF in the registration accept message: i) assigns a new Paging subgroup ID to the UE, then, the AMF shall include the WUS assistance information; or ii) does not assign a Paging subgroup ID to the UE then, the AMF shall not include the WUS assistance information; and initiate the generic UE configuration update procedure.

During this period, if the UE needs to be paged: if in the registration accept message: a new Paging subgroup ID is assigned to the UE that previously has no Paging subgroup ID assigned then, the AMF shall use the new Paging subgroup ID for paging the UE; a new Paging subgroup ID is assigned to the UE that is same as the old Paging subgroup ID then, the AMF shall use the same Paging subgroup ID for paging the UE; and a new Paging subgroup ID is assigned to the UE that is different than the old Paging subgroup ID then, the AMF may first use the old Paging subgroup ID followed by the new Paging subgroup ID for paging the UE.

The AMF selects the 5G-GUTI, and TAI list as follows: the AMF may first use the old 5G-S-TMSI from the old 5G-GUTI for paging within the area defined by the old TAI list for an implementation dependent number of paging attempts using the selected Paging subgroup ID. If a new TAI list was provided in the registration accept message, the new TAI list should also be used for paging. Upon response from the UE, the AMF may initiate the generic UE configuration update procedure. If the response is received from a tracking area within the old and new TAI list, the network shall initiate the generic UE configuration update procedure. If in the registration accept message a new Paging subgroup ID was assigned to the UE that is different than the old Paging subgroup ID then the network shall initiate the generic UE configuration update procedure; and if no response is received to the paging attempts using the old 5G-S-TMSI from the old 5G-GUTI and the old Paging subgroup ID, the AMF may use the new 5G-S-TMSI from the new 5G-GUTI and the new Paging subgroup ID, if any, for paging, for an implementation dependent number of paging attempts. In this case, if a new TAI list was provided with the new 5G-GUTI in the registration accept message, the new TAI list shall be used instead of the old TAI list.

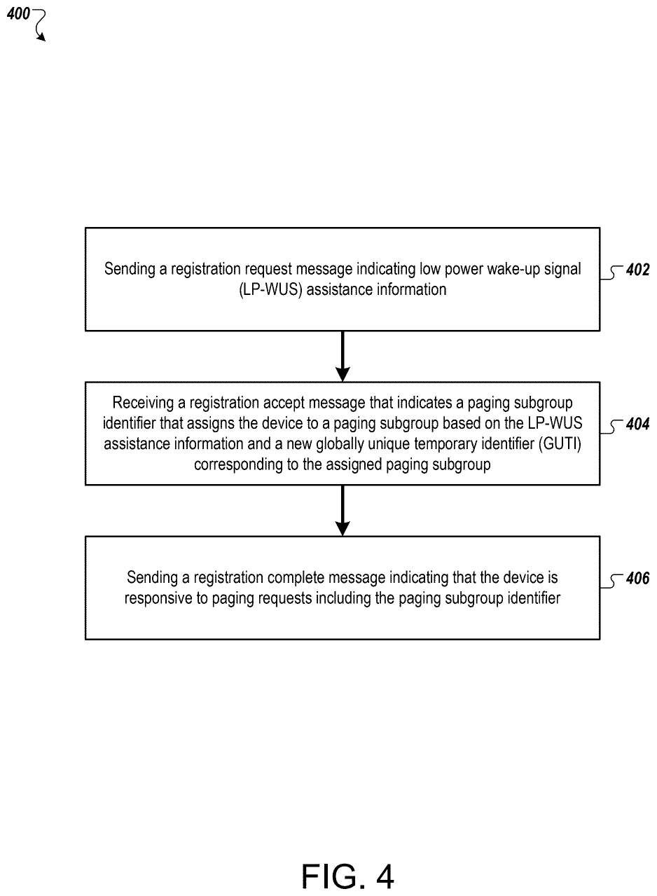

FIG. 4 illustrates an example process 400 for communication of UE preference information. For clarity of presentation, the description that follows generally describes process 400 in the context of the other figures in this description. For example, process 400 can be performed by UE 102 of FIG. 1. It will be understood that process 400 can be performed, for example, by any suitable system, environment, software, hardware, or a combination of systems, environments, software, and hardware, as appropriate. In some implementations, various steps of process 400 can be run in parallel, in combination, in loops, or in any order.

The process 400 for wireless communication can include sending (402) a registration request message indicating low power wake-up signal (LP-WUS) assistance information, the registration request configured to register a device for services from a network. The process 400 can include receiving (404) a registration accept message that indicates a paging subgroup identifier that assigns the device to a paging subgroup based on the LP-WUS assistance information and a new globally unique temporary identifier (GUTI) corresponding to the assigned paging subgroup. The process 400 can include sending (406) a registration complete message indicating that the device is responsive to paging requests including the paging subgroup identifier.

In some implementations, the process 400 includes receiving a configuration update command message indicating an updated paging subgroup identifier for the device; and sending a configuration update complete message indicating that the device is responsive to the updated paging subgroup identifier.

In some implementations, the process 400 includes receiving a paging request that indicates the paging subgroup identifier; and causing activation of a main radio to enter connected mode.

In some implementations, the LP-WUS assistance information comprises a current paging subgroup identifier associated with the device. In some implementations, the LP-WUS assistance information comprises paging probability information indicating a probability that the device is responsive to paging to one or more paging subgroup identifiers. In some implementations, the LP-WUS assistance information comprises device capabilities information indicating one or more of the device supports LP-WUS operation, the device operation capability such as internet of things (IoT) capability, voice centric capability, or a device power profile. In some implementations, the LP-WUS assistance information indicates that the device is not associated with an active emergency packet data unit session.

In some implementations, the process 400 includes receiving a paging request including both an old and a new paging subgroup identifier; and sending an updated service request message and a globally unique temporary identifier (GUTI) associated with old paging subgroup identifier corresponding to a previously successful registration procedure for the services from the network.

In some implementations, the process 400 includes receiving a configuration update command message indicating an updated paging subgroup identifier; and sending a configuration complete message indicating that the device is responsive to paging requests including the updated paging subgroup identifier.

In some implementations, the process 400 includes receiving a configuration update command message indicating a request for the device to send an updated registration request message; and sending the updated registration request message indicating low power wake-up signal (LP-WUS) assistance information associated with the device.

In some implementations, the process 400 includes receiving, from an access node, capabilities information indicating support for core-network paging subgrouping and indicating a number of paging subgroups available for the device; and sending the registration request message based on the capabilities information.

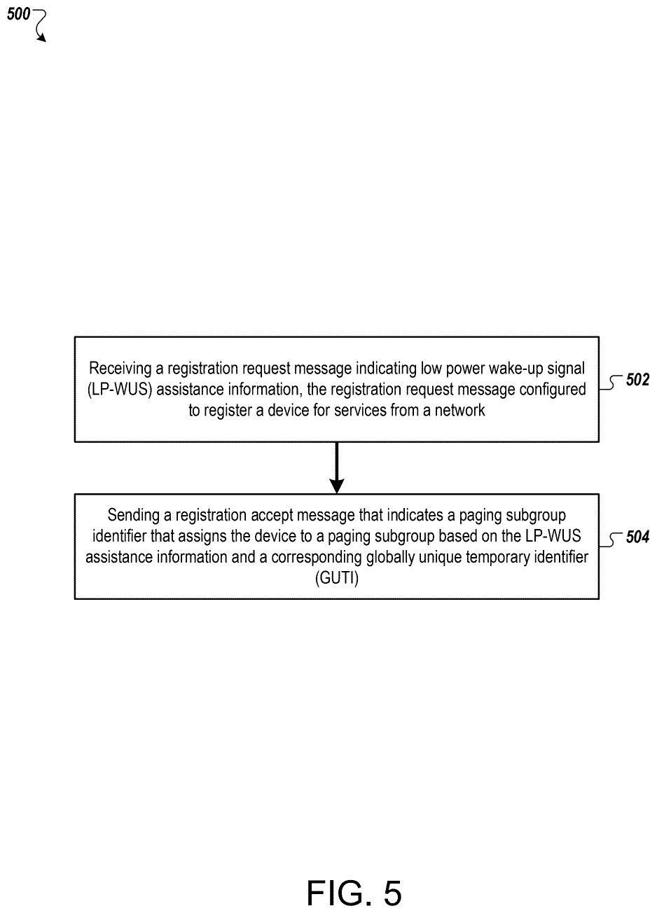

FIG. 5 illustrates an example process 500 for communication of UE preference information. For clarity of presentation, the description that follows generally describes process 500 in the context of the other figures in this description. For example, process 500 can be performed by UE 102 of FIG. 1. It will be understood that process 500 can be performed, for example, by any suitable system, environment, software, hardware, or a combination of systems, environments, software, and hardware, as appropriate. In some implementations, various steps of process 500 can be run in parallel, in combination, in loops, or in any order.

The process 500 for wireless communication can include receiving (502) a registration request message indicating low power wake-up signal (LP-WUS) assistance information, the registration request message configured to register a device for services from a network. The process 500 includes sending (504) a registration accept message that indicates a paging subgroup identifier that assigns the device to a paging subgroup based on the LP-WUS assistance information and a corresponding globally unique temporary identifier (GUTI).

In some implementations, the process 500 includes receiving a registration complete message indicating that the device is responsive to paging requests including the newly assigned paging subgroup identifier; and sending a context modification request message to an access node, the context modification request indicating the new paging subgroup identifier association with the device.

In some implementations, the process 500 includes receiving a context modification response from the access node, the context modification response indicating that the access node successfully updated context information associated with the device.

In some implementations, the process 500 includes receiving a registration complete message indicating that the device is responsive to paging requests including the assigned paging subgroup identifier; sending a configuration update command message indicating a change to the paging subgroup identifier for the device; and receiving a configuration update complete message indicating that the device is responsive to the updated paging subgroup identifier.

In some implementations, the process 500 includes sending a paging request for the device, the paging request indicating the assigned paging subgroup identifier.

In some implementations, the LP-WUS assistance information comprises a current paging subgroup identifier associated with the device.

In some implementations, the LP-WUS assistance information comprises paging probability information indicating a probability that the device is responsive to paging to one or more paging subgroup identifiers.

In some implementations, the LP-WUS assistance information comprises device capabilities information indicating one or more of the device supports LP-WUS operation, the device operation capability such as internet of things (IoT) capability, voice centric capability, or a device power profile.

In some implementations, the LP-WUS assistance information indicates that the device is not associated with an active emergency packet data unit session.

In some implementations, the process 500 includes determining that a registration compete message was not received; sending paging requests including both an old and new paging subgroup identifier; and receiving an updated service request message and an old globally unique temporary identifier (GUTI) corresponding to old paging subgroup identifier associated with a previously successful registration for the services from the network.

In some implementations, the process 500 includes determining that a registration compete message was not received; sending a configuration update command message indicating an updated paging subgroup identifier; and receiving a configuration complete message indicating that the device is responsive to paging requests including the updated paging subgroup identifier.

In some implementations, the process 500 includes determining that a registration compete message was not received; sending a configuration update command message indicating a request for the device to send an updated registration request message; and receiving the updated registration request message indicating low power wake-up signal (LP-WUS) assistance information associated with the device.

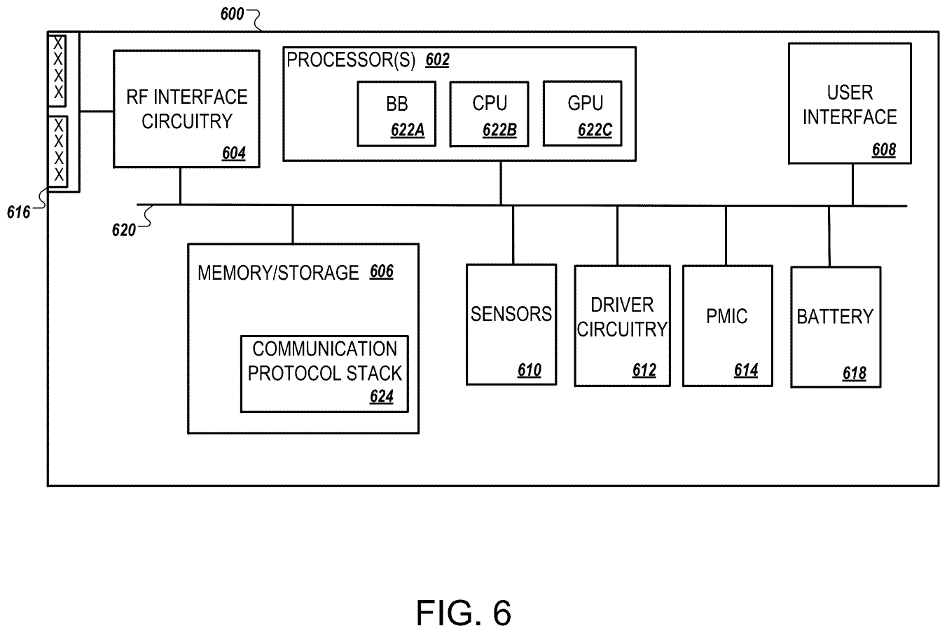

FIG. 6 illustrates a UE 600, according to some implementations. The UE 600 may be similar to and substantially interchangeable with UE 102 of FIG. 1.

The UE 600 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 600 may include processors 602, RF interface circuitry 604, memory/storage 606, user interface 608, sensors 610, driver circuitry 612, power management integrated circuit (PMIC) 614, antenna structure 616, and battery 618. The components of the UE 600 may be implemented as integrated circuits (ICs), portions thereof, discrete electronic devices, or other modules, logic, hardware, software, firmware, or a combination thereof. The block diagram of FIG. 6 is intended to show a high-level view of some of the components of the UE 600. However, some of the components shown may be omitted, additional components may be present, and different arrangement of the components shown may occur in other implementations.

The components of the UE 600 may be coupled with various other components over one or more interconnects 620, which may represent any type of interface, input/output, bus (local, system, or expansion), transmission line, trace, optical connection, etc. that allows various circuit components (on common or different chips or chipsets) to interact with one another.

The processors 602 may include processor circuitry such as, for example, baseband processor circuitry (BB) 622A, central processor unit circuitry (CPU) 622B, and graphics processor unit circuitry (GPU) 622C. The processors 602 may include any type of circuitry or processor circuitry that executes or otherwise operates computer-executable instructions, such as program code, software modules, or functional processes from memory/storage 606 to cause the UE 600 to perform operations as described herein.

In some implementations, the baseband processor circuitry 622A may access a communication protocol stack 624 in the memory/storage 606 to communicate over a 3GPP compatible network. In general, the baseband processor circuitry 622A may access the communication protocol stack to perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 604. The baseband processor circuitry 622A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 606 may include one or more non-transitory, computer-readable media that includes instructions (for example, communication protocol stack 624) that may be executed by one or more of the processors 602 to cause the UE 600 to perform various operations described herein. The memory/storage 606 include any type of volatile or non-volatile memory that may be distributed throughout the UE 600. In some implementations, some of the memory/storage 606 may be located on the processors 602 themselves (for example, L1 and L2 cache), while other memory/storage 606 is external to the processors 602 but accessible thereto via a memory interface. The memory/storage 606 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 604 may include transceiver circuitry and radio frequency front module (RFEM) that allows the UE 600 to communicate with other devices over a radio access network. The RF interface circuitry 604 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 616 and proceed to filter and amplify (with a low-noise amplifier) the signal. The signal may be provided to a receiver of the transceiver that downconverts the RF signal into a baseband signal that is provided to the baseband processor of the processors 602.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 616. In various implementations, the RF interface circuitry 604 may be configured to transmit/receive signals in a manner compatible with NR access technologies.

The antenna 616 may include antenna elements to convert electrical signals into radio waves to travel through the air and to convert received radio waves into electrical signals. The antenna elements may be arranged into one or more antenna panels. The antenna 616 may have antenna panels that are omnidirectional, directional, or a combination thereof to enable beamforming and multiple input, multiple output communications. The antenna 616 may include microstrip antennas, printed antennas fabricated on the surface of one or more printed circuit boards, patch antennas, phased array antennas, etc. The antenna 616 may have one or more panels designed for specific frequency bands including bands in FR1 or FR2.

The user interface 608 includes various input/output (I/O) devices designed to enable user interaction with the UE 600. The user interface 608 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 600.

The sensors 610 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 612 may include software and hardware elements that operate to control particular devices that are embedded in the UE 600, attached to the UE 600, or otherwise communicatively coupled with the UE 600. The driver circuitry 612 may include individual drivers allowing other components to interact with or control various input/output (I/O) devices that may be present within, or connected to, the UE 600. For example, driver circuitry 612 may include a display driver to control and allow access to a display device, a touchscreen driver to control and allow access to a touchscreen interface, sensor drivers to obtain sensor readings of sensor circuitry 610 and control and allow access to sensor circuitry 610, drivers to obtain actuator positions of electro-mechanic components or control and allow access to the electro-mechanic components, a camera driver to control and allow access to an embedded image capture device, audio drivers to control and allow access to one or more audio devices.

The PMIC 614 may manage power provided to various components of the UE 600. In particular, with respect to the processors 602, the PMIC 614 may control power-source selection, voltage scaling, battery charging, or DC-to-DC conversion.

In some implementations, the PMIC 614 may control, or otherwise be part of, various power saving mechanisms of the UE 600. A battery 618 may power the UE 600, although in some examples the UE 600 may be mounted deployed in a fixed location and may have a power supply coupled to an electrical grid. The battery 618 may be a lithium ion battery, a metal-air battery, such as a zinc-air battery, an aluminum-air battery, a lithium-air battery, and the like. In some implementations, such as in vehicle-based applications, the battery 618 may be a typical lead-acid automotive battery.

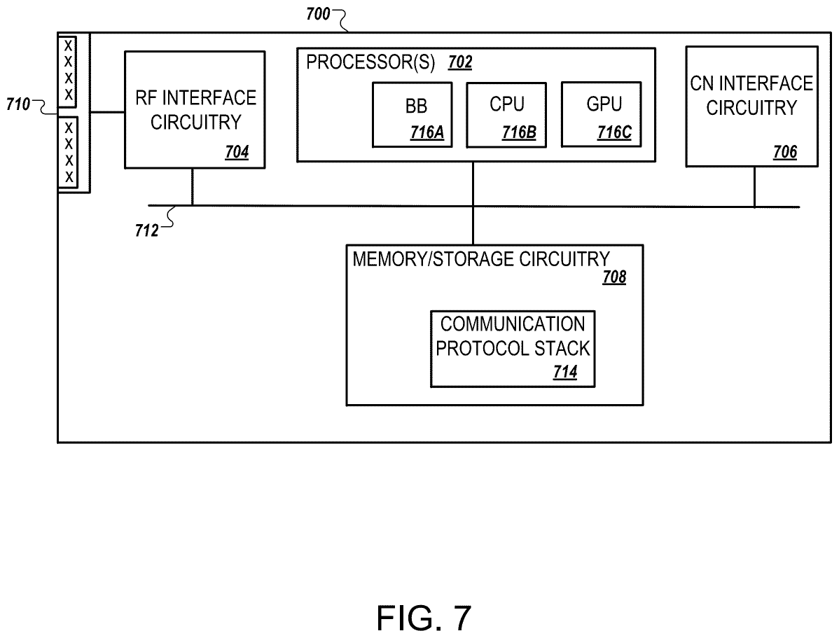

FIG. 7 illustrates an access node 700 (e.g., a base station or gNB), according to some implementations. The access node 700 may be similar to and substantially interchangeable with base station 104. The access node 700 may include processors 702, RF interface circuitry 704, core network (CN) interface circuitry 706, memory/storage circuitry 708, and antenna structure 710.

The components of the access node 700 may be coupled with various other components over one or more interconnects 712. The processors 702, RF interface circuitry 704, memory/storage circuitry 708 (including communication protocol stack 714), antenna structure 710, and interconnects 712 may be similar to like-named elements shown and described with respect to FIG. 6. For example, the processors 702 may include processor circuitry such as, for example, baseband processor circuitry (BB) 716A, central processor unit circuitry (CPU) 716B, and graphics processor unit circuitry (GPU) 716C.

The CN interface circuitry 706 may provide connectivity to a core network, for example, a 5th Generation Core network (5GC) using a 5GC-compatible network interface protocol such as carrier Ethernet protocols, or some other suitable protocol. Network connectivity may be provided to/from the access node 700 via a fiber optic or wireless backhaul. The CN interface circuitry 706 may include one or more dedicated processors or FPGAs to communicate using one or more of the aforementioned protocols. In some implementations, the CN interface circuitry 706 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 700 that operates in an NR or 5G system (for example, a gNB), and the term “E-UTRAN node” or the like may refer to an access node 700 that operates in an LTE or 4G system (e.g., an eNB). According to various implementations, the access node 700 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 700 may be implemented as one or more software entities running on server computers as part of a virtual network, which may be referred to as a CRAN and/or a virtual baseband unit pool (vBBUP). In V2X scenarios, the access node 700 may be or act as a “Roadside Unit.” The term “Roadside Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the examples section.

### Examples

Example 1 is a method including: sending a registration request message indicating low power wake-up signal (LP-WUS) assistance information, the registration request configured to register a device for services from a network; receiving a registration accept message that indicates a paging subgroup identifier that assigns the device to a paging subgroup based on the LP-WUS assistance information and a new globally unique temporary identifier (GUTI) corresponding to the assigned paging subgroup; and sending a registration complete message indicating that the device is responsive to paging requests including the paging subgroup identifier.

Example 2 includes the method of example 1, further including receiving a configuration update command message indicating an updated paging subgroup identifier for the device; and sending a configuration update complete message indicating that the device is responsive to the updated paging subgroup identifier.

Example 3 includes the method of any of examples 1 to 2, further including receiving a paging request that indicates the paging subgroup identifier; and causing activation of a main radio to enter connected mode.

Example 4 includes the method of any of examples 1 to 3, wherein the LP-WUS assistance information comprises a current paging subgroup identifier associated with the device.

Example 5 includes the method of any of examples 1 to 4, wherein the LP-WUS assistance information comprises paging probability information indicating a probability that the device is responsive to paging to one or more paging subgroup identifiers.

Example 6 includes the method of any of examples 1 to 5, wherein the LP-WUS assistance information comprises device capabilities information indicating one or more of the device supports LP-WUS operation, the device operation capability such as internet of things (IoT) capability, voice centric capability, or a device power profile.

Example 7 includes the method of any of examples 1 to 6, wherein the LP-WUS assistance information indicates that the device is not associated with an active emergency packet data unit session.

Example 8 includes the method of any of examples 1 to 7, further including receiving a paging request including both an old and a new paging subgroup identifier; and sending an updated service request message and a globally unique temporary identifier (GUTI) associated with old paging subgroup identifier corresponding to a previously successful registration procedure for the services from the network.

Example 9 includes the method of example 8, further including receiving a configuration update command message indicating a request for the device to send an updated registration request message; and sending the updated registration request message indicating low power wake-up signal (LP-WUS) assistance information associated with the device.

Example 10 includes the method of any of examples 1 to 9, further including receiving, from an access node, capabilities information indicating support for core-network paging subgrouping and indicating a number of paging subgroups available for the device; and sending the registration request message based on the capabilities information.

Example 11 includes a method comprising receiving a registration request message indicating low power wake-up signal (LP-WUS) assistance information, the registration request message configured to register a device for services from a network; and sending a registration accept message that indicates a paging subgroup identifier that assigns the device to a paging subgroup based on the LP-WUS assistance information and a corresponding globally unique temporary identifier (GUTI).

Example 12 includes the method of example 11, further including receiving a registration complete message indicating that the device is responsive to paging requests including the newly assigned paging subgroup identifier; and sending a context modification request message to an access node, the context modification request indicating the new paging subgroup identifier association with the device.

Example 13 includes the method of any of examples 11 to 12, further including receiving a context modification response from the access node, the context modification response indicating that the access node successfully updated context information associated with the device.

Example 14 includes the method of any of examples 11 to 13, further including receiving a registration complete message indicating that the device is responsive to paging requests including the assigned paging subgroup identifier; sending a configuration update command message indicating a change to the paging subgroup identifier for the device; and receiving a configuration update complete message indicating that the device is responsive to the updated paging subgroup identifier.

Example 15 includes the method of any of examples 11 to 14, further including sending a paging request for the device, the paging request indicating the assigned paging subgroup identifier.

Example 16 includes the method of any of examples 11 to 15, wherein the LP-WUS assistance information comprises a current paging subgroup identifier associated with the device.

Example 17 includes the method of any of examples 11 to 16, wherein the LP-WUS assistance information comprises paging probability information indicating a probability that the device is responsive to paging to one or more paging subgroup identifiers.

Example 18 includes the method of any of examples 11 to 17, wherein the LP-WUS assistance information comprises device capabilities information indicating one or more of the device supports LP-WUS operation, the device operation capability such as internet of things (IoT) capability, voice centric capability, or a device power profile.

Example 19 includes the method of any of examples 11 to 18, wherein the LP-WUS assistance information indicates that the device is not associated with an active emergency packet data unit session.

Example 20 includes the method of any of examples 11 to 19, further including determining that a registration compete message was not received; sending paging requests including both an old and new paging subgroup identifier; and receiving an updated service request message and an old globally unique temporary identifier (GUTI) corresponding to old paging subgroup identifier associated with a previously successful registration for the services from the network.

Example 21 includes the method of any of examples 11 to 20, further including determining that a registration compete message was not received; sending a configuration update command message indicating an updated paging subgroup identifier; and receiving a configuration complete message indicating that the device is responsive to paging requests including the updated paging subgroup identifier.

Example 22 includes the method of any of examples 11 to 21, further including determining that a registration compete message was not received; sending a configuration update command message indicating a request for the device to send an updated registration request message; and receiving the updated registration request message indicating low power wake-up signal (LP-WUS) assistance information associated with the device.

Example 23 is an apparatus including one or more processors configured to perform the method of any of examples 1-22.

Example 24 is a UE including: one or more processors; and memory storing instructions that, when executed by the one or more processors, cause the UE to perform the method of any of examples 1-10.

Example 25 is an access node including: one or more processors; and memory storing instructions that, when executed by the one or more processors, cause the access node to perform the method of any of examples 11-22.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A method for wireless communication, comprising:
sending a registration request message indicating low power wake-up signal (LP-WUS) assistance information to register a device for one or more services from a network;
receiving a registration accept message that indicates a paging subgroup identifier that assigns the device to a paging subgroup based on the LP-WUS assistance information and a globally unique temporary identifier (GUTI) corresponding to the assigned paging subgroup; and
sending a registration complete message indicating that the device is responsive to paging requests including the paging subgroup identifier.

2. The method of claim 1, further comprising:
receiving a configuration update command message indicating an updated paging subgroup identifier for the device; and
sending a configuration update complete message indicating that the device is responsive to the updated paging subgroup identifier.

3. The method of claim 1, further comprising:
receiving a paging request that indicates the paging subgroup identifier; and
causing activation of a main radio to enter a connected mode.

4. The method of claim 1, wherein the LP-WUS assistance information comprises a paging subgroup identifier that is currently associated with the device.

5. The method of claim 1, wherein the LP-WUS assistance information comprises paging probability information indicating a probability that the device is responsive to paging to each of one or more paging subgroup identifiers.

6. The method of claim 1, wherein the LP-WUS assistance information comprises device capabilities information indicating one or more of a support for LP-WUS operation, an internet of things (IoT) capability, a voice centric capability, or a device power profile.

7. The method of claim 1, wherein the LP-WUS assistance information indicates that the device is not associated with an active emergency packet data unit session.

8. The method of claim 1, further comprising:
receiving a paging request including both an old paging subgroup identifier and a new paging subgroup identifier; and
sending an updated service request message and a globally unique temporary identifier (GUTI) associated with the old paging subgroup identifier corresponding to a previously successful registration procedure for the services from the network.

9. The method of claim 8, further comprising:
receiving a configuration update command message indicating an updated paging subgroup identifier; and
sending a configuration complete message indicating that the device is responsive to paging requests including the updated paging subgroup identifier.

10. The method of claim 8, further comprising:
receiving a configuration update command message indicating a request for the device to send an updated registration request message; and
sending the updated registration request message indicating low power wake-up signal (LP-WUS) assistance information associated with the device.

11. The method of claim 1, further comprising:
receiving, from an access node, capabilities information indicating support for core-network paging subgrouping and indicating a number of paging subgroups available for the device; and
sending the registration request message based on the capabilities information.

12. One or more processors in communication with a memory storing instructions, that, when executed by the one or more processors, cause the one or more processors to perform operations comprising:
receiving a registration request message indicating low power wake-up signal (LP-WUS) assistance information, the registration request message configured to register a device for services from a network; and
sending a registration accept message that indicates a paging subgroup identifier that assigns the device to a paging subgroup based on the LP-WUS assistance information and a corresponding globally unique temporary identifier (GUTI).

13. The one or more processors of claim 12, the operations further comprising:
receiving a registration complete message indicating that the device is responsive to paging requests including the paging subgroup identifier that is assigned; and
sending a context modification request message to an access node, the context modification request indicating the paging subgroup identifier associated with the device.

14. The one or more processors of claim 13, the operations further comprising:
receiving a context modification response from the access node, the context modification response indicating that an access node successfully updated context information associated with the device.

15. The one or more processors of claim 12, the operations further comprising:
receiving a registration complete message indicating that the device is responsive to paging requests including the paging subgroup identifier that is assigned;
sending a configuration update command message indicating a change to the paging subgroup identifier for the device; and
receiving a configuration update complete message indicating that the device is responsive to the updated paging subgroup identifier.

16. The one or more processors of claim 12, the operations further comprising:
sending a paging request for the device, the paging request indicating the paging subgroup identifier that is assigned.

17. The one or more processors of claim 12, wherein the LP-WUS assistance information comprises paging probability information indicating a probability that the device is responsive to paging to each of one or more paging subgroup identifiers.

18. The one or more processors of claim 12, the operations further comprising:
determining that a registration compete message was not received;
sending paging requests including both an old paging subgroup identifier and a new paging subgroup identifier; and
receiving an updated service request message and an old globally unique temporary identifier (GUTI) corresponding to the old paging subgroup identifier associated with a previously successful registration for the services from the network.

19. The one or more processors of claim 12, the operations further comprising:
determining that a registration compete message was not received;
sending a configuration update command message indicating an updated paging subgroup identifier; and
receiving a configuration complete message indicating that the device is responsive to paging requests including the updated paging subgroup identifier.

20. The one or more processors of claim 12, the operations further comprising:
determining that a registration compete message was not received;
sending a configuration update command message indicating a request for the device to send an updated registration request message; and
receiving the updated registration request message indicating low power wake-up signal (LP-WUS) assistance information associated with the device.
